(19) United States
(12) Patent Application Publication
(10) Pub. No.: US 2024/0400286 A1
(43) Pub. Date: Dec. 5, 2024

(54) SUSTAINABLE BARRIER BOARDS AND ASSOCIATED FOOD PACKAGES AND METHODS

(71) Applicant: WestRock MWV, LLC, Atlanta, GA (US)

(72) Inventors: Chitai C. YANG, Glen Allen, VA (US); Chloe RADIGAN, Atlanta, GA (US); Zack SIMONCELLI, Richmond, VA (US); William STATELMAN, Richmond, VA (US)

(21) Appl. No.: 18/666,410

(22) Filed: May 16, 2024

Related U.S. Application Data
(60) Provisional application No. 63/505,088, filed on May 31, 2023.

(51) Int. Cl. B65D 81/24; B32B 27/10; B32B 33/00; B32B 37/06; B32B 37/24; B65D 65/42; B65D 65/46

(52) U.S. Cl. CPC B65D 81/245; B32B 27/10; B32B 33/00; B32B 37/06; B32B 37/24; B65D 65/42; B65D 65/466; B32B 2037/243; B32B 2250/03; B32B 2250/40; B32B 2255/10; B32B 2255/26; B32B 2260/046; B32B 2307/73; B32B 2317/18

(57) ABSTRACT

A sustainable barrier board comprising: a cellulosic board substrate having a first major side and a second major side; a hydrophobic substance impregnated into the cellulosic board substrate; a first biopolymer barrier film on the first major side of the cellulosic board substrate; and a first biopolymer heat sealable coating coupling the first biopolymer barrier layer with the first major side of the cellulosic board substrate.

### PRIORITY

This application claims priority from U.S. Ser. No. 63/505,088 filed on May 31, 2023, the entire contents of which are incorporated herein by reference.

### FIELD

The present application relates to the field of packaging materials, and more specifically to a barrier board such as for bacon packaging that offers oil and grease resistance, moisture resistance, and sustainability while being printable.

### BACKGROUND

The packaging industry has long faced the challenge of developing sustainable, environmentally friendly materials that can meet the performance demands of various products, including barrier boards with high grease and moisture content such as bacon. Bacon products are typically packaged using a stiff board that supports the slices of bacon and allows for easy handling and display. Most of the conventional bacon boards, however, are not recyclable. The incumbent bacon board is a waxed paperboard bacon board having an extruded low-density polyethylene on both sides of the waxed board, which carries no sustainability claims for recyclability or compostability.

Recently, an alternative bacon board made of polypropylene film has been introduced. This material offers several advantages over traditional boards, such as being recyclable in the polypropylene recycle stream. However, despite its recyclability, it still contributes to plastic waste because most bacon boards end up as waste in landfills.

There is a growing need for a more sustainable and eco-friendlier alternative to traditional barrier boards that can reduce the environmental impact of packaging and meet the demands of consumers and packagers. This alternative may ideally be oil and grease resistant, moisture resistant, and heat-sealable to address the increasing demand for sustainable packaging solutions in the commercial sector.

Accordingly, those skilled in the art continue with research and development in the field of sustainable barrier boards to address these challenges and provide an environmentally responsible alternative to conventional materials, while ensuring the required performance characteristics are met.

### SUMMARY

Disclosed are sustainable barrier boards.

In one example, the disclosed sustainable barrier board comprises: a cellulosic board substrate having a first major side and a second major side; a hydrophobic substance impregnated into the cellulosic board substrate; a first biopolymer barrier film on the first major side of the cellulosic board substrate; and a first biopolymer heat sealable coating coupling the first biopolymer barrier layer with the first major side of the cellulosic board substrate.

Disclosed are methods for manufacturing sustainable barrier boards.

In one example, the method comprises: providing a cellulosic board substrate having a first major side and a second major side, the cellulosic board substrate having a hydrophobic substance impregnated into the cellulosic board substrate; coating a first biopolymer heat sealable coating on a first biopolymer barrier film; and heat seal laminating the first biopolymer barrier film to the first major side of the cellulosic board substrate.

Disclosed are bacon boards comprising the sustainable barrier boards.

Also disclosed are food packages for high grease and/or moisture content food product comprising the sustainable barrier board.

Other examples of the disclosed sustainable barrier boards, methods of manufacturing thereof, bacon boards and food packages will become apparent from the following detailed description, the accompanying drawings and the appended claims.

### BRIEF DESCRIPTION OF THE DRAWINGS

FIG. 1 is a cross-section of an exemplary sustainable barrier board according to an example of the present application, prior to lamination;

FIG. 2 is a cross-section of the exemplary sustainable barrier board of FIG. 1, after lamination; and

FIG. 3 is an illustration of an exemplary food packaging according to the present description.

### DETAILED DESCRIPTION

The present description relates to a sustainable barrier board comprising: a cellulosic board substrate having a first major side and a second major side; a hydrophobic substance impregnated into the cellulosic board substrate; a first biopolymer barrier film on the first major side of the cellulosic board substrate; and a first biopolymer heat sealable coating heat sealing the first biopolymer barrier layer to the first major side of the cellulosic board substrate. The sustainable barrier board may further comprise a second biopolymer barrier film on the second major side of the cellulosic board substrate; and a second biopolymer heat sealable coating heat sealing the second biopolymer barrier layer to the second major side of the cellulosic board substrate.

The cellulosic board substrate of the present description is a porous, stiff material formed from a network of cellulose fibers. The cellulose fibers may be derived from plant sources, such as wood, bamboo, or agricultural by-products. The cellulosic board substrate can have various thicknesses, densities, and mechanical properties depending on the intended application and may include additives or treatments to enhance its performance characteristics. The cellulosic board substrate may be single ply construction or multi-ply construction. The cellulosic board substrate may be a paperboard substrate created through a papermaking process. Paperboard substrates can exhibit a wide range of properties, such as grammage, caliper, and stiffness, and may be single or multi-ply constructions depending on the specific requirements of the application.

The hydrophobic substance of the present description is a material that is incorporated into the cellulosic board substrate to provide oil and grease resistance and moisture resistance and enhance the overall durability of the board in the presence of high grease and moisture content. This hydrophobic substance can be selected from a variety of materials. The choice of hydrophobic substance will depend on factors such as the desired level of oil and grease resistance and moisture resistance, substrate properties, intended application, and environmental impact considerations.

In an aspect, the hydrophobic substance impregnated into the cellulosic board substrate may be wax. Wax may be a preferred hydrophobic substance for the sustainable barrier board due to its compatibility with cellulosic materials, ease of application, wide availability, and adaptability to various performance requirements. Additionally, waxes can offer desirable properties, such as resistance to microbial growth, which can help maintain the quality of the packaged product and prolong its shelf life.

The wax may be a natural wax. Natural waxes are derived from natural sources and can break down over time through natural processes, making them a more environmentally friendly choice for the sustainable barrier board. Examples of natural waxes include beeswax, which is produced by honeybees, plant-based waxes such as carnauba wax, which is obtained from the leaves of the Copernicia prunifera palm, and soy wax, which is derived from soybean oil. These natural waxes align with the sustainability goals of the barrier board, as they contribute to a reduced environmental impact by decomposing into natural by-products when disposed of in suitable conditions.

The wax may also be a synthetic wax. Non-limiting examples of suitable synthetic waxes include paraffin wax, microcrystalline wax, polyethylene wax, Fischer-Tropsch wax, and combinations thereof.

The wax, or other hydrophobic substance, may be impregnated into the cellulosic board substrate using various methods to distribute the material throughout the substrate, providing effective moisture and oil and grease resistance. These methods include dipping, spraying, melt-extrusion, roller coating, curtain coating, and other wax impregnation methods. The choice of impregnation method will depend on factors such as the desired distribution, substrate properties, and manufacturing capabilities.

The first and second biopolymer barrier films of the present description are continuous layers of biopolymer material that provide enhanced barrier properties to the sustainable barrier board, particularly in terms of resistance to moisture, grease, and oil absorption from the contents of the package. This improved resistance helps maintain the integrity and functionality of the barrier board. The biopolymer barrier films also contribute to the compostable and environmentally friendly aspects of the barrier board. The biopolymer barrier films may also provide printability.

The biopolymer barrier films may be formed separately from the cellulosic board substrate and then heat laminated onto the respective major sides of the impregnated cellulosic board substrate. For example, the biopolymer barrier films may be precoated with a biopolymer heat sealable coating, and the biopolymer heat sealable coating may facilitate heat lamination/scaling.

The biopolymer material for the biopolymer barrier films may be selected to maintain the integrity of the film at the heat sealing temperature applied during heat sealing to laminate the biopolymer barrier films to the cellulosic board substrate. For example, the biopolymer for the biopolymer barrier film may be selected to have a softening temperature of at least 58° C., such as at least 60° C., or at least 70° C., or at least 80° C., or at least 90° C., or at least 100° C., or at least 110° C., or at least 120° C., or at least 130° C., or at least 140° C., or at least 150° C., or at least 160° C., or at least 170° C., or at least 180° D. A suitable biopolymer that can be used for the barrier films is cellulose acetate, e.g., cellulose diacetate or cellulose triacetate. Other suitable biopolymers that may be used for the barrier films may include, for example, polylactic acid (PLA), polybutylene adipate co-terephthalate (PBAT), and polyhydroxyalkanoates (PHA).

The biopolymer barrier films can be manufactured using various processes, such as extrusion or casting, depending on the specific properties of the biopolymer material, desired film characteristics, and production capabilities. The biopolymer barrier films can be made with single or multi-layer constructions, incorporating additional layers or coatings to further enhance barrier properties or other performance attributes, such as printability.

The first and second biopolymer heat sealable coatings of the present description facilitate the heat sealing of the biopolymer barrier films to the respective major sides of the cellulosic board substrate. These coatings can be composed of biopolymer materials that exhibit good adhesion to both the cellulosic board substrate and the barrier films, as well as suitable heat-sealing properties. The biopolymer material for the biopolymer heat sealable coatings may be selected to soften at the heat sealing temperature applied during heat sealing to laminate the biopolymer barrier films to the cellulosic board substrate. For example, the biopolymer for the biopolymer heat sealable coatings may be selected to have a softening temperature of 180° C. or less, such as 170° C. or less, or 160° C. or less, or 150° C. or less, or 140° C. or less, or 130° C. or less, or 120° C. or less, or 110° C. or less, or 100° C. or less, or 90° C. or less, or 80° C. or less, or 70° C. or less, or 60° C. or less, or 58° C. or less. The biopolymers for the biopolymer heat scalable coatings and the biopolymer barrier film may be selected such that a softening temperature of the biopolymer heat sealable coatings is less than a softening temperature of the biopolymer barrier film. A suitable biopolymer material that can be used for the coatings is polybutylene succinate (PBS). Examples of other biopolymer materials that may be used for the coatings include, but are not limited to, polyethylene furanoate (PEF), polybutylene adipate co-terephthalate (PBAT), polycaprolactone (PCL), and other biodegradable or compostable polymers with heat-scaling properties.

Biopolymer barrier films can be laminated onto impregnated cellulosic board substrates using various methods to ensure proper adhesion and performance. These methods may include, for example, thermal lamination (with techniques such as hot roll lamination, hot calendering, and drum heating), ultrasonic lamination, as well as any other suitable lamination methods. Factors that influence the choice of lamination method include the specific properties of the biopolymer heat sealable coating and the cellulosic board substrate, desired bond strength, production capabilities, and environmental considerations.

The sustainable barrier boards described herein are intended to be industrially compostable, adhering to recognized international standards such as ASTM D6400 (American Society for Testing and Materials) and EN 13432 (European Standard). These standards establish guidelines and requirements for the compostability of plastic materials under controlled composting conditions, such as those found in industrial composting facilities. Industrial composting facilities maintain specific conditions, such as controlled temperature, humidity, and aeration, which accelerate the composting process. These controlled environments ensure that materials break down into carbon dioxide, water, and biomass within a set timeframe, typically around 12 weeks for ASTM D6400 and EN 13432 standards. To meet the ASTM D6400 and EN 13432 criteria, the sustainable barrier boards fulfill requirements for biodegradability, disintegration, and absence of ecotoxicity. By meeting these criteria, the sustainable barrier boards offer an environmentally friendly alternative to conventional barrier boards that are not compostable, reducing the impact on landfills and contributing to a more circular economy.

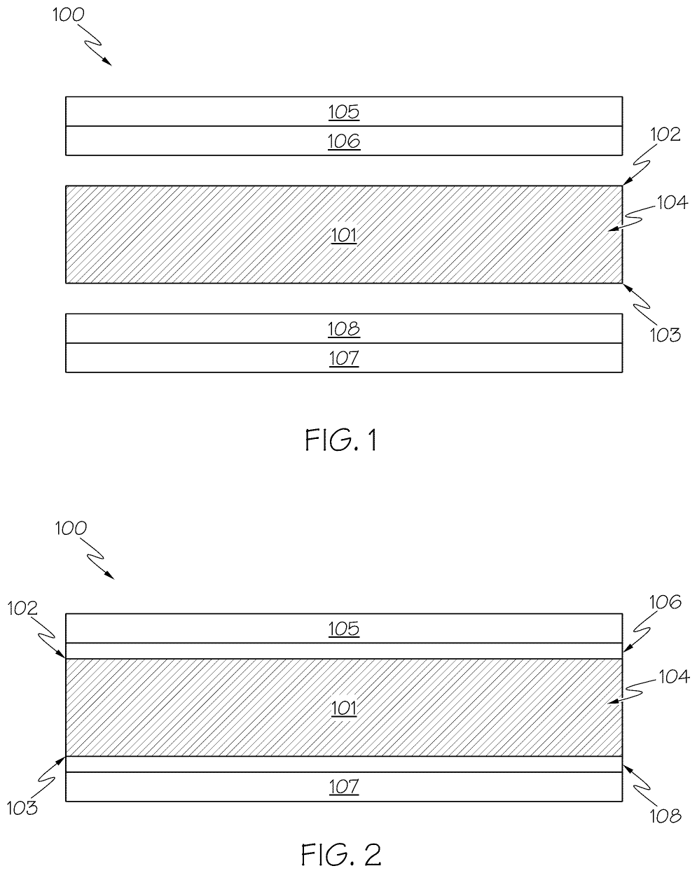

FIG. 1 illustrates a cross-section of a sustainable barrier board (100) according to an example of the present application, prior to lamination. FIG. 2 illustrates a cross-section of the exemplary sustainable barrier board (100), after lamination. The cross-sectional view shows the various layers and components of the barrier board. A cellulosic board substrate (101) is shown at the center of the barrier board (100), which has a first major side (102) and a second major side (103). The cellulosic board substrate (101) is made from a network of cellulose fibers, providing the primary structural support for the barrier board. A hydrophobic substance (104), such as wax, is impregnated into the cellulosic board substrate (101) to provide oil and grease resistance, as well as moisture resistance. A first biopolymer barrier film (105) is applied to the first major side (102) of the cellulosic board substrate (101). This barrier film provides additional protection against moisture, grease, and oil absorption. A first biopolymer heat sealable coating (106) is on the first biopolymer barrier film (105) and heat seals the first biopolymer barrier film (105) to the first major side (102) of the cellulosic board substrate (101). A second biopolymer barrier film (107) is applied to the second major side (103) of the cellulosic board substrate (101), providing similar barrier properties as the first biopolymer barrier film (105). A second biopolymer heat sealable coating (108) is on the second biopolymer barrier film (107) and heat seals the second biopolymer barrier film (107) to the second major side (103) of the cellulosic board substrate (101). The sustainable barrier board illustrated in FIGS. 1 and 2 is a multi-layered structure designed to provide enhanced barrier properties and heat sealability, while maintaining environmental sustainability through the use of biopolymer materials and a cellulosic board substrate.

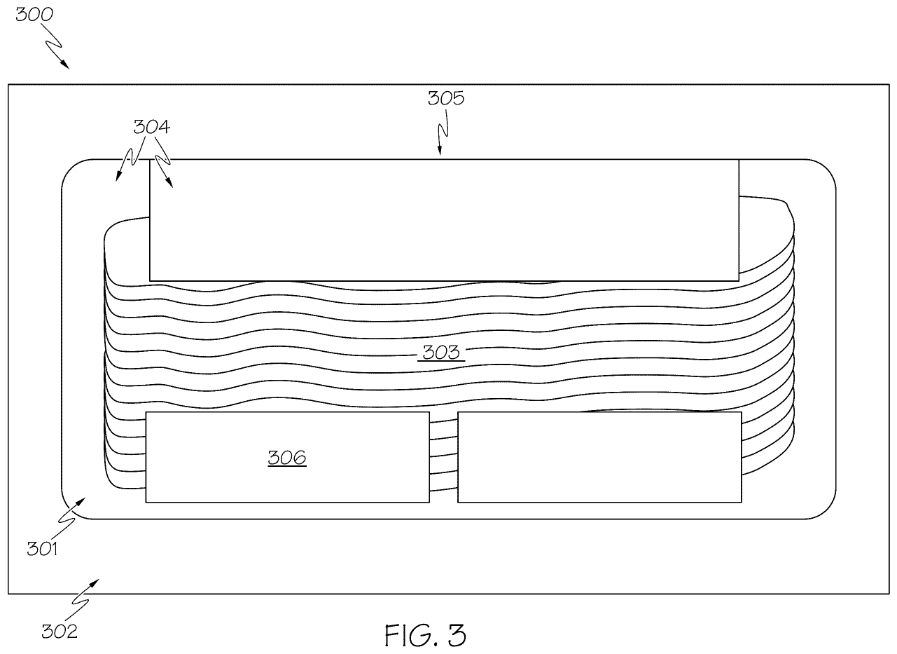

FIG. 3 illustrates an exemplary food packaging (300) designed for high grease and/or moisture content food products, such as bacon slices (303).

As depicted in FIG. 3, the food packaging (300) comprises an L-shaped bacon board (301) and a transparent plastic covering (302) that encases both the bacon slices (303) and the bacon board (301). The L-shaped bacon board (301) serves as a rigid backing to support the bacon slices (303) while also providing a surface (304) for graphics, logos, and other relevant product information. The L-shaped bacon board (301) may be folded along fold line (305) to form front and back sides of the bacon board.

The plastic covering (302) can be, for example, a vacuum-sealed bag or a shrink-wrapped film, designed to preserve the freshness and extend the shelf life of the bacon (303) by preventing oxygen and moisture from entering the package. Preferably, the plastic covering (302) is compostable to enhance environmental sustainability of the entire food packaging (300). Additionally, this transparent plastic covering (302) allows consumers to visually inspect the quality and appearance of the bacon (303) through a small window (306) located on the back of the package.

The L-shaped bacon board (301) comprises the sustainable barrier board (100), as described in the present application, with biopolymer barrier films (105, 107) applied to both major sides (102, 103) of the cellulosic board substrate (101). This construction provides enhanced grease and moisture resistance for the packaging (300), while maintaining environmental sustainability through the use of the biopolymer materials and the cellulosic board substrate. Various modifications and adaptations can be made to the packaging design.

The examples below illustrate various lamination configurations and testing methods for creating and evaluating the performance of sustainable barrier boards.

### Example 1: F2SX1 Lamination Configuration—Two-Sided Lamination—Benchtop Laminator

In this configuration, the heat-sealable film is applied on both sides of a waxed paperboard bacon board and fed through a benchtop laminator at a speed of 12 inches/min set at 100° C., followed by a cold roller. The heat-sealable film is made of cellulose acetate precoated with compostable Bio-PBS biopolymer as the heat sealant layer.

### Example 2: F1SX2 Lamination Configuration—One-Sided Lamination with Two Passes—Hot Calender

In this configuration, the heat-sealable film is applied on one side of a waxed paperboard bacon board and fed through a hot calender at a speed of 12 ft/min set at 230° F., followed by a cold roller. The same process is repeated on the second (opposite) side of the waxed bacon board in the second pass. The heat-sealable film is made of cellulose acetate precoated with compostable Bio-PBS biopolymer as the heat sealant layer.

### Example 3: F1SX2 Lamination Configuration—One-Sided Lamination with Two Passes—Drum Heater

In this configuration, the heat-sealable film is applied on one side of the waxed paperboard bacon board and fed through a drum heater at a speed of 12 ft/min set at 230° F., followed by a cold roller. The same process is repeated on the second (opposite) side of the waxed bacon board in the second pass. The heat-sealable film is made of cellulose acetate precoated with compostable Bio-PBS biopolymer as the heat sealant layer.

### Comparative Example 4: Incumbent Bacon Board with Two-Sided Extruded LDPE

The incumbent bacon board is a waxed paperboard bacon board with extruded low-density polyethylene on both sides of the waxed board. This board does not carry sustainability claims for recyclability or compostability.

The laminated boards from examples 1 to 3 and comparative example 4 were tested for oil absorption and adhesion.

### Oil Absorption Test

Laminated boards were cut into 2 inch by 6 inch strips and submerged in a corn oil bath under 0.1 MPa vacuum for 25 seconds. Weight gain due to corn oil absorption before and after submergence was calculated as a percentage or expressed by edge wick in centigrams per 100-inch perimeter. Example 1 showed an edge wick of about 2.0 centigrams per 100-inch perimeter, Example 2 had an edge wick of about 4.2 centigrams per 100-inch perimeter, Example 3 had an edge wick of about 7.8 centigrams per 100-inch perimeter, and Comparative Example 4 had an edge wick of about 7.5 centigrams per 100-inch perimeter. The current manufacturing quality specification is a maximum of 15 centigrams per 100-inch perimeter.

Although various examples of the disclosed sustainable barrier board, method for manufacturing thereof, bacon board, and food packaging have been shown and described, modifications may occur to those skilled in the art upon reading the specification. The present application includes such modifications and is limited only by the scope of the claims.

What is claimed is:

1. A sustainable barrier board comprising:
a cellulosic board substrate having a first major side and a second major side;
a hydrophobic substance impregnated into the cellulosic board substrate;
a first biopolymer barrier film on the first major side of the cellulosic board substrate; and
a first biopolymer heat sealable coating coupling the first biopolymer barrier film with the first major side of the cellulosic board substrate.

2. The sustainable barrier board of claim 1, wherein the hydrophobic substance impregnated into the cellulosic board substrate is wax.

3. The sustainable barrier board of claim 1, wherein the hydrophobic substance impregnated into the cellulosic board substrate is a synthetic wax.

4. The sustainable barrier board of claim 1, wherein the hydrophobic substance impregnated into the cellulosic board substrate is paraffin wax.

5. The sustainable barrier board of claim 1, wherein the hydrophobic substance impregnated into the cellulosic board substrate is a natural wax.

6. The sustainable barrier board of claim 1, wherein the first biopolymer barrier film comprises cellulose acetate.

7. The sustainable barrier board of claim 1, wherein the first biopolymer heat sealable coating comprises polybutylene succinate.

8. The sustainable barrier board of claim 1, further comprising:
a second biopolymer barrier film on the second major side of the cellulosic board substrate; and
a second biopolymer heat sealable coating heat sealing the second biopolymer barrier film to the second major side of the cellulosic board substrate.

9. A bacon board comprising the sustainable barrier board of claim 1.

10. A food package for high grease and/or moisture content food product, the food package comprising the sustainable barrier board of claim 1.

11. A food package comprising:
the sustainable barrier board of claim 1; and
bacon in contact with the sustainable barrier board.

12. A method for manufacturing a sustainable barrier board, the method comprising:
providing a cellulosic board substrate having a first major side and a second major side, the cellulosic board substrate having a hydrophobic substance impregnated into the cellulosic board substrate;
coating a first biopolymer heat sealable coating on a first biopolymer barrier film; and
laminating the first biopolymer barrier film to the first major side of the cellulosic board substrate.

13. The method of claim 12, wherein the laminating includes thermal lamination.

14. The method of claim 13, wherein the thermal lamination, includes at least one of hot roll lamination, hot calendering, and drum heating.

15. The method of claim 12, further comprising:
coating a second biopolymer heat sealable coating on a second biopolymer barrier film; and
laminating the second biopolymer barrier film to the second major side of the cellulosic board substrate.

16. The method of claim 15, wherein the first and second biopolymer barrier films are laminated simultaneously.

17. The method of claim 15, wherein the first and second biopolymer barrier films are laminated sequentially.
